(19) United States
(12) Patent Application Publication
(10) Pub. No.: US 2014/0279580 A1
(43) Pub. Date: Sep. 18, 2014

(54) Systems and methods for managing transmission service reservations

(71) Applicant: Open Access Technology International, Inc., Minneapolis, MN (US)

(72) Inventors: Khashayar Nodehi Fard Haghighi, Maple Grove, MN (US); Paul Raymond Sorenson, Tega Cay, SC (US); Kevin John Sarkinen, Greenfield, MN (US); Sasan Mokhtari, Eden Prarie, MN (US)

(73) Assignee: Open Access Technology International, Inc., Minneapolis, MN (US)

(21) Appl. No.: 14/216,226

(22) Filed: Mar. 17, 2014

Related U.S. Application Data
(60) Provisional application No. 61/791,828, filed on Mar. 15, 2013.

(51) Int. Cl. G06Q 50/06; G06Q 10/10

(52) U.S. Cl. CPC G06Q 50/06; G06Q 10/10
USPC 705/309

(57) ABSTRACT

A system and method for producing recommended Transmission Service Reservation (TSR) actions based upon existing TSRs and existing rights of first refusal on those TRSs whereby challengers are identified, defenders are identified, and TSRs are evaluated for Preemption and Competition to produce a preemption and completion report containing recommended TSR actions. Such a method uses a capacity computation, existing TSR records, and the event of a newly pending TSR in its procedures. Recommended TSR actions may include confirmation of TSRs, recalling of TSRs, and submitting of matching TSRs.

### CROSS-REFERENCE TO RELATED APPLICATIONS

This application claims priority to provisional patent application No. 61/791,828 filed Mar. 15, 2013, the entire contents of which are hereby incorporated by reference.

Applicant has other co-pending applications directed to the energy market, namely: SYSTEMS AND METHODS FOR DEMAND RESPONSE AND DISTRIBUTED ENERGY RESOURCE MANAGEMENT, filed Feb. 9, 2011 and assigned application Ser. No. 13/024,158, the entire contents of which is hereby incorporated by reference.

AUTOMATION OF ENERGY TRADING, filed Dec. 30, 2011 and assigned application Ser. No. 13/140,248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054,611, the entire contents of which is hereby incorporated by reference.

A renewable energy credit management system and method, filed Feb. 10, 2014 and assigned application Ser. No. 14/176,590, the entire contents of which is hereby incorporated by reference.

Systems and methods of determining optimal scheduling and dispatch of power resources, filed on Mar. 17, 2014 (Docket No. O17.2P-15315-US03), the entire contents of which is hereby incorporated by reference.

Systems and methods for managing energy generation and procurement, filed on Mar. 17, 2014 (Docket No. O17.2P-15469-US03), the entire contents of which is hereby incorporated by reference.

Systems and methods for tracing electrical energy of a load to a specific generator on a power grid, filed on Mar. 17, 2014 (Docket No. O17.2P-15493-US03), the entire contents of which is hereby incorporated by reference.

Systems and methods for trading electrical power, filed on Mar. 17, 2014 (Docket No. O17.2P-15565-US03), the entire contents of which is hereby incorporated by reference.

Systems and methods for managing conditional curtailment options, filed on Mar. 17, 2014 (Docket No. O17.2P-15571-US03), the entire contents of which is hereby incorporated by reference.

Systems and methods for tracking greenhouse gas emissions, filed on Mar. 17, 2014 (Docket No. O17.2P-15954-US02), the entire contents of which is hereby incorporated by reference.

Systems and methods for parameter estimation for use in determining value-at-risk, filed on Mar. 17, 2014 (Docket No. O17.2P-15955-US02), the entire contents of which is hereby incorporated by reference.

Systems and methods for interfacing an electrical energy end user with a utility, filed on Mar. 17, 2014 (Docket No. O17.2P-15958-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. O17.2P-15959-US02), the entire contents of which is hereby incorporated by reference.

### STATEMENT REGARDING FEDERALLY SPONSORED RESEARCH

Not Applicable

### FIELD OF THE INVENTION

The invention relates to the field of Transmission Tariff management in use within or with a Transmission Management System, Congestion Management System, or systems of similar nature or purpose. The invention can be used to manage Transmission Service Reservations in respect to existing Right-Of-First-Refusal on those Transmission Requests.

### BACKGROUND OF THE INVENTION

The FERC Pro-Form a Open Access Transmission Tariff (OATT) provides for the preemption of lower priority transmission service requests and reservations, referred to as “defenders”, by higher priority service requests, referred to as “challengers”, under Sections 13.2 and 14.2 respectively. Certain preempted transmission service reservations must also be extended an opportunity to exercise a “right of first refusal” to retain their service by meeting or exceeding the term of service of the “challenging” request, i.e., competition. The invention addresses the need for automated identification of opportunities for the preemption and competition for transmission service, and the recommended actions to be taken to conform with the requirements of the OATT. Specifically the identification of a valid challenger, determination of the deficit in transmission capability that must be acquired through preemption and competition to grant service to the challenger, identification of the eligible defenders needed to mitigate the deficiency, extending the “right of first refusal” to eligible defenders, and determining the final outcome of the preemption and competition process. This analysis was typically performed manually by the transmission provider operators, and is extremely time consuming, onerous, and prone to errors in implementation. As such, this process was often not performed or only applied under a limited number of circumstances. The invention automates this process in a concise and reproducible manner to improve operational efficiency and promote open and non-discriminatory access to the transmission system.

### BRIEF SUMMARY OF THE INVENTION

A method for producing recommended Transmission Service Reservation (TSR) actions taking into account existing TSRs and existing rights of first refusal on those TRSs whereby challengers are identified, defenders are identified, and TSRs are evaluated for Preemption and Competition to produce a preemption and completion report containing recommended TSR actions. Recommended TSR actions may include confirmation of TSRs, recalling of TSRs, and submitting of matching TSRs. The method disclosed allows for a fast, methodical, and less error prone method of honoring right of first refusal on existing transmission service agreements. The method disclosed uses a capacity computation, existing TSR records, and the event of a newly pending TSR in its procedures.

### BRIEF DESCRIPTION OF DRAWINGS

FIG. 1 is a block diagram illustrating data flow through the disclosure

FIG. 2 is a block diagram illustrating data flow through the Identification of Challenger process.

FIG. 3 is a block diagram illustrating data flow through the Identification of Defender process.

FIG. 4 is a block diagram illustrating data flow through the Evaluation for Preemption and Competition.

FIG. 5 is a block diagram illustrating a computer system that may be utilized in the performance of the disclosed methods and processes.

### DETAILED DESCRIPTION OF THE INVENTION

The invention aims to provide a method of providing recommendations and actions on transmission service reservations (TSRs) in conformance with FERC pro form a Open Access Transmission Tariff and Industry Standards and best practices with respect to the honoring of reservation priorities and the Right-Of-First-Refusal (ROFR) should there be insufficient Available Transfer Capability (ATC) to grant new requests for service. An embodiment of the invention can fully automate the Preemption and Competition business process for both “contract-path” and “flow-based” Available Flow Gate Capability (AFC) computation solutions.

The invention may be used where any of the following transmission tariff characteristics are to be implemented:
Firm transmission service requests may displace (preempt), in whole or in part, any Conditional Firm service of shorter duration or of equal duration but lower price; the displaced service Customer has the Right of First Refusal to match the longer duration or higher price request. Short-Term Firm service may displace, in whole or in part, any Non-Firm service or Network service from non-designated resources; the displaced service Customer has no Right of First Refusal.
Network service from non-designated resources may displace, in whole or in part, any Non-Firm service; the displaced service Customer has no Right of First Refusal.
Non-Firm service may displace (preempt), in whole or in part, any Non-Firm service of shorter duration or any pending Non-Firm service of equal duration but lower price; the displaced service Customer has the Right of First Refusal to match the longer duration or higher priced request.

Generally the Right of First Refusal (ROFR) on a TSR is interpreted to preserve a customer's priority, usually based on request queued time, to receive transmission service in the amount they originally were granted. To exercise their ROFR to retain their transmission service, the customer's matching request must minimally retain the originally granted capacity over the original term of the reservation and, for the term of service beyond the originally granted term that is required to meet or exceed the longer duration request, the capacity requested must be for at least the amount of capacity that is subject to displacement by the longer term request. For example, if a transmission customer holding 5 megawatts (MWs) of service is displaced in whole by another customer's longer duration request for 10 MWs, the original customer's ROFR is exercised by matching or exceeding the duration of the higher priority request in the amount of at least 5 MWs. It is assumed the original customer is not required to match the capacity of the higher priority request or to request duration longer than the higher priority request.

North American Energy Standards Board (NAESB) Business Practice Standards specify the relative priorities of service as outlined above for six “Tiers” of service:
Tier 1: Native load, Network, or Long-term Firm.
Tier 2: Short-term Firm.
Tier 3: Network Service from Non-designated Resources.
Tier 4: Non-firm.
Tier 5: Non-firm Point-to-Point Service over secondary receipt and delivery points.
Tier 6: Non-firm Next Hour Market Service.

These standards also require that a TSR must be Pre-confirmed and of a flat (equal) MW capacity over time to initiate the Preemption and Competition process. Within a given “Tier” of service, the following are the relative priorities for the key transmission service request attributes to be used in identifying candidates for preemption and competition as set forth in NAESB Standards in support of FERC Order 890 (and its progeny):
Service increment—The basic intervals of service (HOURLY, DAILY, WEEKLY, etc.) with longer increment services having priority over shorter increments.
Duration—Overall time interval spanned from start of service to the end of service.
Pre-confirmation—Attribute indicating to the Transmission Provider that the Customer is committing to take and pay for service if granted by the Provider.
Price—The incremental price (to be) paid by the Customer on granting of service.
Submission queue time—The time stamp provided on OASIS when the request for service was submitted.

The preemption and competition process intends to respect service priority within those services that are identified as candidates for preemption. As requests or reservations are identified as preemption candidates (the Defenders), there may be situations where preemption of a lower priority request/reservation may be insufficient to award service to the request initiating preemption (the Challenger), while preemption of a higher priority candidate would allow such service to be awarded. In such situations, both preemption candidates will be acted on even though only the higher priority candidate is actually needed to fulfill the Challenger's request. The rule implemented is that if a given candidate request or reservation is to be preempted, all lower priority candidate requests/reservations should also be subject to preemption assuming that all such Defenders contribute to meeting of Available Flow Gate Capability or Available Transmission Capacity, hereinafter both referred to as capacity, deficiencies that are limiting the service that may be granted to the Challenger.

Additional restrictions are placed on Defenders that are to be afforded the ROFR. First, if it is determined that a ROFR may not be offered to the Defender due to other commitments or constraints, that Defender and ALL higher priority Defenders will not be subject to preemption and competition. Extending a ROFR opportunity to a preemption candidate will not itself initiate further preemptions. This further reinforces the stipulation within the preemption and competition process that a lower priority reservation will not be left in place and not impacted at the expense of preemption and/or competition of a higher priority reservation.

In assessing the feasibility of granting a ROFR to a preempted reservation, a user of the invention may configure the invention to either require that all ROFR matching opportunities are simultaneously feasible, or the feasibility of offering a ROFR to a given Defender will be determined independently of any other Defender's ROFR to comport with the FERC rulings to offer a “simultaneous matching” opportunity.

Due to the frequency of Newly Pending TSRs in need of evaluation and the complexity of the review required, the manual review of the existing Challengers and Defenders proves to be incredibly time consuming and error prone. As the electricity markets continue to commoditize, the need for fast review of the rights involved increases.

An embodiment of the invention identifies and recommends opportunities for the preemption and competition of lower priority services with an efficiency and accuracy not possible by human monitoring alone. The invention produces a Preemption and Competition Module (PCM) Evaluation Report 107 providing details that include, but are not limited to, RECALL profile recommendations for specified TSRs in the competition, Feasible MATCHING profile recommendations for specified TSRs in the competition, a final profile for the Challenger TSR, a list of TSRs considered for the competition and an amount of the deficient capacity identified in the competition. This report can aid Transmission Provider Operators or Transmission Systems in accurately implementing the results of a competition.

In one embodiment utilizing a computer, the invention is able to implement the recommended preemption and competition opportunities on either a fully or partially automated basis or through Transmission Provider Operator initiated actions. Where the same review and actions taken manually could have taken days, the invention can produce the same results without error in seconds.

The invention requires at least three inputs for operation: a set of transmission Capacity Computation Results 100, a set of TSR Records 101, and a Newly Pending TSR 102.

Capacity Computation Results 100 typically consist of an AFC/ATC, (Capacity) Calculation process on only two separate AFC/ATC computations: one for all Firm services which includes only the impacts for Firm service, and one for all Non-firm services which includes the impacts of all Firm and Non-firm services.

A set of TSR Records 101 is the set of TSRs stored in a database that a Newly Pending Transmission Service Request 102 will be compared against for the purpose of preemption and competition.

The invention's processes are triggered when a Newly Pending TSR 102 is submitted into the Transmission Management System 103 and there is insufficient capacity to grant the requested transmission service in full.

The invention typically resides within a Transmission Management System 103. This consists of any system used for the scheduling and management of TSRs and Requests. Another embodiment of the invention exists outside of at Transmission Management System 103 but interacts directly with it.

When a Newly Pending TSR 102 enters the invention or a Transmission Management System 103 containing the invention, the first process of the invention is initiated. Typically this is Identification of the Challenger 104. Identification of the Challenger 104 is followed by Identification of the Defenders 105, and Evaluation for Preemption and Competition 106. After the Evaluation for Preemption and Competition 106 is completed, a PCM Evaluation Report is produced 107.

When a Newly Pending TSR 102 is evaluated by the Transmission Management System 103 and it is found that there is insufficient capacity to grant the request in full, the Identification of Challenger 104 process is initiated. The purpose of the Identification of Challenger 104 process is to determine if the Newly Pending TSR 105 qualifies as a valid Challenger for Preemption and Competition. The Identification of Challenger process (FIG. 2.) checks the following conditions:
Service Validation 200: Requested Service must be configured as a valid Challenging service.
Deficiency Validation 201: Request must be deficient on one or more flowgates (FGs) or contract paths (CPs).
Lead Time Validation 202: Request submission time must be more than the “Minimum lead time for Preemption” prior to start of service as defined for the service. Additional conditions may be present in other embodiments. These include, but are not limited to:
Preconfirmed Validation 203: Request must be preconfirmed.
Profile Validation 204: Request must be of flat requested MW capacity profile over the entire term of the TSR.

If the TSR does not meet any of the validations, a Fail Result 206 is set for that TSR and the invention does not continue to the next process for the Newly Pending TSR 102 in question.

After the Identification of Challenger 104 process determines the Newly Pending TSR 102 is a valid Challenger, the Identification of Defenders 105 process is initiated. The Identification of Defenders 105 process will first search the TSR Records 101 for three types of defenders:
At-risk (A-)Defenders—Pending, prior queued requests of lower service priority than the Challenger, and that impact one or more of the Challenger's deficient FGs/CPs over time.
Blocking (B-)Defenders—Confirmed reservations of lower service priority than the Challenger that are conditional as defined in the OATT, and that impact one or more of the Challenger's deficient FGs/CPs over time, but do not have the Right of First Refusal
Competing (C-)Defenders—Confirmed reservations of lower service priority than the Challenger that are conditional as defined in the OATT, and that impact one or more of the Challenger's deficient FGs/CPs over time, and that have the Right of First Refusal.

Each of the defenders identified are examined in the following validations (FIG. 3):
Overlap Validation 300: Defender must overlap in time some portion of the Challenger.
Queue Time Validation 301: Defender must be queued prior to the Challenger.
Impact Validation 302: Defender must significantly impact one or more of the Challenger's deficient FGs or CPs over the same time interval as the Challenger.
Evaluation Time Validation 303: Confirmed TSRs (B and C-Defenders) must be “conditional”, i.e., service start time less the current evaluation time must be greater than the Unconditional Lead Time.

Any TRSs not meeting the criteria are given a Fail Result 304 and are removed from the A, B, and C Defender Lists. After this removal the remaining list of TSRs are moved to the Select and Order process 305 is initiated. For each of the classifications of A, B, and C-Defenders this process selects and orders all Defenders by the Defending Service's Rank. Within a given Rank, all Defenders are ordered by: Duration (shorter to longer); Pre-confirmation status (NO to YES) (CONFIRMED Defenders shall always be considered as Preconfirmed=YES); If IgnorePrice is NOT set, Price (low to high); and Queue time (newest to oldest).

After the Select and Order 305 process has completed, the TSR lists may move to the appropriate Evaluation Process. The A Defender Evaluation, Firm B and C Evaluation, and Non Firm B and C Evaluation each evaluate a separate group of TSRs and may do so independently of each other.

The A Defender Evaluation 306 process removes or excludes TSRs from the list of A-Defenders that meet the following criteria:
For any TSR of longer Duration: TSRs that have any periods of time with a 0 MW capacity will be evaluated with an effective duration equal to the TSR's total duration of service minus the sum of all intervals in time with 0 MW capacity. Another embodiment of the invention may have a configurable or varying rule governing treatment of duration for TSRs with intervals at 0 MW capacity
If Challenger is Preconfirmed: Any TSR of equal Duration, that is preconfirmed, with a met price condition. Price conditions will vary from embodiment to embodiment. Typically the price condition is set to ignore the price or require a higher price than the Challengers price. When set to ignore, the price condition is always met. When set to require a higher price, the price condition is met when the Defender's price is equal to or higher than the Challenger's price.
If Challenger is not Preconfirmed: Any TSR of equal Duration that is Preconfirmed or any TSR of equal Duration, not Preconfirmed, with the price condition met.

The Firm B and C Evaluation 307 process removes or excludes TSRs from the list of B, or C-Defenders that meet the following criteria:
For any TSR of longer Duration: TSRs that have any periods of time with a 0 MW capacity will be evaluated with an effective duration equal to the TSR's total duration of service minus the sum of all intervals in time with 0 MW capacity. Another embodiment of the invention may have a configurable or varying rule governing treatment of duration for TSRs with intervals at 0 MW capacity.
If Challenger is Preconfirmed: Any TSR of equal Duration, that is preconfirmed, with a met price condition. Price conditions will vary from embodiment to embodiment. Typically the price condition is set to ignore the price or require a higher price than the Challengers price. When set to ignore, the price condition is always met. When set to require a higher price, the price condition is met when the Defender's price is equal to or higher than the Challenger's price.

The Non-Firm B and C Evaluation 308 process removes or excludes TSRs from the list of B, or C-Defenders that meet the following criteria:
Any TSR of longer Duration that have any periods of time with a 0 MW capacity will be evaluated with an effective duration equal to the TSR's total duration of service minus the sum of all intervals in time with 0 MW capacity. Other embodiments of the invention may have differing rules governing treatment of duration for TSRs with intervals at 0 MW capacities.

After the Identification of Defenders 105 is complete the Evaluation for Preemption and Competition 106 process is initiated. An embodiment of the Evaluation for Preemption and Competition 106 process may take the following steps to evaluate the feasibility for preemption and competition to meet the Challenger's request. Prior to evaluating the potential for Preemption and Competition of any B or C-Defender, all prior-queued Challengers that also identify these TSRs as target Defenders must be resolved; preemption of A-Defenders (pending requests) can be identified and typically acted on immediately. To execute the steps of the Evaluation for Preemption and Competition 106 an embodiment of the invention may (FIG. 4):

Step 1: Determine Best Partial Service 401. Determine the best partial service offer available to the Challenger (by definition the evaluation for preemption and competition should never be performed if the Challenger can be awarded service at the requested capacity over time).

Step 2: Log Best Partial Service 402. Log the best partial service offer available without preemption and competition.

Step 3: In Progress Check 403. If any of the A, B, or C-Defender TSRs are identified as being a participant (either Defender or Challenger) in an active preemption and competition in progress, suspend Evaluation for Preemption and Competition 106 process and log the identification of the Challenging TSR(s) and all of its Defenders with those currently being competed. The criteria to identify any prior active preemption and competition in progress shall ensure that all FGs and CPs that are significantly impacted by the Challenger or any of the identified Defenders will be considered; any subsequent preemption and competition action that impacts one (1) or more of the same FGs or CPs over the same time interval will be blocked until the prior preemption and competition process has been resolved.

Step 4: FG Capture 404. Capture the list of deficient FGs and/or CPs.

Step 5: A-Defender Impact Check 405. For each A-Defender in priority order (lowest to highest): Check that the A-Defender significantly impacts one or more FGs or CPs still deemed to be deficient, and if no deficiency remains for those FGs or CPs significantly impacted by the Defender, move on to the next A-Defender; Remove all AFC/ATC impacts for the Defender; if the deficiency on any FG and/or CP has been relieved, (i.e., resulting AFC or ATC is greater than or equal to 0), remove that FG and/or CP from the list of remaining deficient FGs and CPs; recompute the best partial service offer that may be extended to the Challenger; log the action to be taken on the Defender as ‘SUPERSEDE’; if the Challenger can be granted in full, no further Defender evaluations are necessary; else, continue evaluation with the next A-Defender.

Then compute the Challenger's remaining FG and CP deficiencies over time with all A-Defender and later queued TSR impacts removed.

Step 6: B-Recalls 406. For each B-Defender in priority order (lowest to highest): For each Deficient FG or CP compute the minimum MW capacity that must be recalled from the Defender TSR to meet the deficiency of the Challenger over time. For over all Deficient FGs and CPs: Determine the maximum MW capacity over time that must be recalled from the Defender TSR to meet the worst case deficiency of the Challenger. “Re-shape” the RECALL profile into increments of service no shorter than the configured RecallIncrement specified for the Defender's service. Log the action to be taken on the Defender as “RECALL” and capture the RECALL Profile to be applied to the Defender. Compute the credit to AFC/ATC gained on each of the Challenger's Deficient FGs or CPs based on the recall profile to be applied to the Defender and apply that credit to Challenger's remaining deficiencies over time. If all FG and CP deficiencies have been met, no further Defender evaluations are necessary. Else, continue evaluation with the next B-Defender.

Step 7: Best Offer Computation 407. Compute the best (partial) service offer that may be extended to the Challenger resulting from preemption of A and B-Defenders.

Step 8: Grant in Full Check 408. If the Challenger may be granted in full with preemption of A and B-Defenders, log the actions to be taken on all identified Defenders and proceed to PCM Evaluation Report 107.

Step 9: C-Defender Competition 409. The following evaluation of C-Defender competitions may require an iterative process of first identifying the ALL of the RECALL credits that may be gained by the preemption and competition of the C-Defender and then assessing the feasibility of the C-Defender's right to exercise their ROFR, i.e., match. If a C-Defender's right to match the Challenger is deemed infeasible, that C-Defender in addition to all higher priority C-Defenders will be removed from the competition. This requires that all recall credits gained from those C-Defenders must also be removed, and the entire competition must be reassessed. This reassessment may, in turn, find that previously feasible match opportunities are no longer feasible and additional C-Defenders must be removed from contention. This process will proceed until a feasible set of competitions is determined or all C-Defenders are considered ineligible.

For each C-Defender in priority order (lowest to highest), determine the recall credits and matching requirements for competition: for each Deficient FG or CP compute the minimum MW capacity that must be recalled from the Defender TSR to meet the deficiency of the Challenger over time.

Over all Deficient FGs and CPs: determine the maximum MW capacity over time that must be recalled from the Defender TSR to meet the worst case deficiency of the Challenger. “Re-shape” the recall profile into increments of service no shorter than the configured RecallIncrement specified for the Defender's service. Apply the credit to ATC/AFC of the resultant recall profile to the remaining FG and CP deficiencies for use in the subsequent Defender evaluations.

Compute the MATCHING Profile required to exercise ROFR for the Defender as follows: compute the MW capacity profile required over the original term of the Defender. If the Defender service increment is identical to the Challenger, set the MW capacity required over the original term of the Defender service to be equal to the Defender's current capacity profile impacting AFC/ATC. Else, for each of the Challenger's increments of service that overlap the Defender, set the MW capacity required over each of those increments of service to the maximum MW capacity held by the Defender within that increment.

In addition, if the Defender is of shorter duration than the Challenger, compute the required extension to the term of service to match the Challenger according to the following:
If the Match Profile Type is fill:
   And if the Defender TSR starts prior to the term of the Challenger: The Maximum MW value of the recall profile computed over time for the Defender extended beyond (from) the Defender's stop time to the point in time where the Defender's original start time through to the extended stop time would equal the duration of the Challenger.
   And if the Defender TSR ends after the term of the Challenger: The Maximum MW value of the recall profile computed over time for the Defender extended prior to the Defender's start time to the point in time where the extended start time through the Defender's original stop time would equal the duration of the Challenger.
   And if the Defender TSR is within the term of the Challenger: The Maximum MW value of the recall profile computed over time for the Defender extended backward to the Challenger's start time plus that Maximum MW value of the recall profile extended forward to the Challenger's stop time.
If the Match Profile Type is extend: The Maximum MW value of the recall profile computed over time for the Defender extended beyond (from) the Defender's stop time to the point in time where the Defender's original start time through to the extended stop time would equal the duration of the Challenger.

If all FG and CP deficiencies have been met, no further Defender evaluations are necessary. Else, continue evaluation with the next C-Defender.

Step 10: C Defender Matching 410. For each remaining C-Defender in priority order (lowest to highest), determine the feasibility of the matching requirements for competition. The impact of the Challenger on ATC/AFC must be removed from consideration in performing this assessment.

Apply a credit to ATC/AFC in the amount of the Defender's remaining capacity impacting ATC/AFC and determine the feasibility to accommodate the required matching capacity profile over time with the remaining ATC/AFC. Note that the matching requirement computed above includes the capacity of the original Defender, and replaces the Defender in full if ROFR is exercised.

If the C-Defender's matching requirement is NOT feasible, remove the C-Defender and all higher priority C-Defenders from further consideration, and recompute the recall credits and matching requirements for competition based on only those C-Defenders remaining eligible for competition.

If the C-Defender's matching requirement IS feasible AND “SimultaneousMatching” is disabled: leave the impact of the matching capacity profile on ATC/AFC in place for the evaluation of each subsequent C-Defender matching requirement and log the action to be taken on the C-Defender as compete, along with its associated recall and matching profiles.

If the C-Defender's matching requirement IS feasible AND “SimultaneousMatching” is enabled: remove the impact of the matching capacity profile on ATC/AFC but reinstate the impact of the C-Defender and credit for the associated recall for the evaluation of each subsequent C-Defender matching requirement and log the action to be taken on the C-Defender as compete, along with its associated RECALL and matching profiles.

Step 11: Final Challenger Assessment 411. Perform the final assessment of the Challenger by incorporating all superceded and RECALL credits gained from preemption and competition but excluding all potential MATCHING impacts from competition.

Step 12: Partial Service Log 412. Compute and log the best partial service offer that may be extended to the Challenger resulting from preemption and competition of all qualifying A, B, and C-Defenders.

If only partial service is available and the Challenger service is configured with “FullServiceRequired” enabled, log the preemption and competition validation as a FAIL and flag all preemption and competition log records captured as “information only” and not to be acted on.

If the best partial service offer that may be extended to the Challenger resulting from preemption and competition of all A, B, and C-Defenders is no better than the partial service offer available without any preemption and competition actions, log the preemption and competition validation as a FAIL and flag all preemption and competition log records captured as “information only” and not to be acted on.

If the best partial service offer that may be extended to the Challenger resulting from preemption and competition of all A, B, and C-Defenders is no better than the partial service offer available with only preemption of A-Defenders, clear all preemption and competition actions for the B and C-Defenders leaving only the supercede of A-Defenders in place and proceed to the PCM Evaluation Report 107.

Using the results and logs of the Evaluation for Preemption and Competition 106 process a PCM Evaluation Report 107 is generated. This report may include but is not limited to recall profile recommendations for specified TSRs in the competition, Feasible matching profile recommendations for specified TSRs in the competition, a final profile for the Challenger TSR, a list of TSRs considered for the competition and an amount of the deficient capacity identified in the competition.

Some or all of the previously discussed embodiments may be performed utilizing a computer or computer system. An example of such a computer or computer system is illustrated in FIG. 5. Computer 600 contains Central Processing Unit 601. Central Processing Unit 601 may perform some or all of the processes involved in the previously discussed embodiments. Central Processing Unit 601 may utilize information contained in Memory 602, Database 603, or both. Central Processing Unit 601 may also write information to Memory 602, Database 603, or both. While in this FIG. 5 only one Computer 600 is shown, some embodiments may make use of multiple computers or computer systems. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

What is claimed is:

1. A method for managing transmission service reservations (TSR), comprising the steps of:
providing a set of transmission capacity computation results;
providing a database of transmission service reservation records;
receiving a newly pending TSR;
determining that there is insufficient capacity to grant the newly pending TSR in full;
identifying the challenger;
identifying the defenders;
evaluation for preemption and competition, and
producing a PCM evaluation report.

2. The method of claim 1 wherein identifying the challenger further comprises the steps of:
determining that the newly requested service is configured as a valid challenging service;
determining that the newly requested service request must be deficient on one or more flowgates (FGs) or contract paths (CPs), and
determining whether the request was made more than the predetermined minimum lead time for preemption, prior to start of service as defined for the service.

3. The method of claim 2 further including the step of determining whether the request was preconfirmed.

4. The method of claim 2 further including the step of determining whether the request was of flat requested MW capacity profile over the entire term of the requested TSR.

5. The method of claim 1 wherein identifying the defenders comprises the steps of:
determining whether the defender is an A type defender, which is a defender with pending, prior queued requests of lower service priority than the challenger, and that impact one or more of the challenger's deficient FGs/CPs over time;
determining whether the defender is a B type defender, which is a defender with confirmed reservations of lower service priority than the challenger that are conditional as defined in the OATT, and that impact one or more of the challenger's deficient FGs/CPs over time, but do not have the right of first refusal, and
determining whether the defender is a C type defender, which is a defender with confirmed reservations of lower service priority than the challenger that are conditional as defined in the OATT, and that impact one or more of the challenger's deficient FGs/CPs over time, and that have the right of first refusal.

6. The method of claim 5 further wherein the defender is further validated that:
defender must overlap in time some portion of the challenger;
defender must be queued prior to the challenger;
defender must significantly impact one or more of the challenger's deficient FGs or CPs over the same time interval as the challenger, and
confirmed TSRs (B and C-Defenders) must be “conditional”, with service start time less the current evaluation time must be greater than the unconditional lead time.

7. The method of claim 6 wherein for each of the A, B, and C defender lists are prioritized first by:
duration, from shortest to longest; then
pre-confirmation status, from NO to YES; then
if ignore price is not set, price, from low to high, and then
queue time, from newest to oldest.

8. The method of claim 7 wherein each A defender is excluded if:
TSRs that have any periods of time with a 0 MW capacity will be evaluated with an effective duration equal to the TSR's total duration of service minus the sum of all intervals in time with 0 MW capacity;
any TSR of equal Duration, that is preconfirmed, with a met price condition, and
any TSR of equal Duration that is Preconfirmed or any TSR of equal Duration, not Preconfirmed, with the price condition met.

9. The method of claim 8 wherein each B or C defender is excluded if:
TSRs that have any periods of time with a 0 MW capacity will be evaluated with an effective duration equal to the TSR's total duration of service minus the sum of all intervals in time with 0 MW capacity, and
any TSR of equal Duration, that is preconfirmed, with a met price condition.

10. The method of claim 8 wherein each non-firm B and C evaluation is excluded if:
any TSR of longer duration that have any periods of time with a 0 MW capacity will be evaluated with an effective duration equal to the TSR's total duration of service minus the sum of all intervals in time with 0 MW capacity.

11. The method of claim 8 wherein the evaluation for preemption and competition is comprised of the steps of:
determining the best partial service offer available to the challenger;
logging the best partial service offer available without preemption and competition;
if any of the A, B, or C-Defender TSRs are identified as being a participant (either defender or challenger) in an active preemption and competition in progress, suspend evaluation for preemption and competition
processing and log the identification of the challenging TSR(s) and all of its defenders with those currently being competed;
capturing the list of deficient FGs and/or CPs;
for each A-Defender in priority order (lowest to highest), checking that the A-Defender significantly impacts one or more FGs or CPs still deemed to be deficient, and if no deficiency remains for those FGs or CPs significantly impacted by the Defender;
computing and log the best (partial) service offer that may be extended to the challenger resulting from preemption of A-Defenders;
computing the challenger's remaining FG and CP deficiencies over time with all A-Defender and later queued TSR impacts removed;
for each B-Defender in priority order (lowest to highest), for each deficient FG or CP compute the minimum MW capacity that must be recalled from the Defender TSR to meet the deficiency of the challenger over time;
for over all Deficient FGs and CPs, determine the maximum MW capacity over time that must be recalled from the Defender TSR to meet the worst case deficiency of the challenger;
Compute the best (partial) service offer that may be extended to the challenger resulting from preemption of A and B-Defenders, and
a check is performed to determine if challenger may be granted in full with preemption of A and B-Defenders.

12. The method of claim 11 wherein if the check is performed and the challenger may not be granted in full with preemption of A and B-Defenders, perform an iterative process of first identifying ALL of the RECALL credits that may be gained by the preemption and competition of the C-Defender and then assessing the feasibility of the C-Defender's right to exercise their ROFR.

13. The method of claim 12 wherein if the defender is of shorter duration than the challenger, compute the required extension to the term of service to match the challenger.

14. The method of claim 13 wherein for each remaining C-Defender in priority order from lowest to highest, determine the feasibility of the MATCHING requirements for competition.

15. The method of claim 14 wherein a final assessment of the challenger is performed by incorporating all SUPERCEDED and RECALL credits gained from preemption and competition but excluding all potential MATCHING impacts from competition.

16. The method of claim 15 further including the step of computing and logging the best partial service offer that may be extended to the challenger resulting from preemption and competition of all qualifying A, B, and C-Defenders.

17. A system for managing transmission service reservations (TSR), comprising:
a computer program for use with a computer having a memory;
the computer program configured to:
provide a set of transmission capacity computation results;
provide a database of transmission service reservation records;
receive a newly pending TSR;
determine that there is insufficient capacity to grant the newly pending TSR in full;
identify the challenger;
identify the defenders;
evaluate for preemption and competition, and
produce a PCM evaluation report.

18. The system of claim 17 wherein identifying the challenger comprises:
determining that the newly requested service is configured as a valid challenging service;
determining that the newly requested service request must be deficient on one or more flowgates (FGs) or contract paths (CPs), and
determining whether the request was made more than the predetermined minimum lead time for preemption, prior to start of service as defined for the service.

19. The system of claim 18 further including determining whether the request was preconfirmed.

20. The system of claim 18 further including determining whether the request was of flat requested MW capacity profile over the entire term of the requested TSR.

21. The system of claim 17 wherein identifying the defenders comprises:
determining whether the defender is an A type defender, which is a defender with pending, prior queued requests of lower service priority than the challenger, and that impact one or more of the challenger's deficient FGs/CPs over time;
determining whether the defender is a B type defender, which is a defender with confirmed reservations of lower service priority than the challenger that are conditional as defined in the OATT, and that impact one or more of the challenger's deficient FGs/CPs over time, but do not have the right of first refusal, and
determining whether the defender is a C type defender, which is a defender with confirmed reservations of lower service priority than the challenger that are conditional as defined in the OATT, and that impact one or more of the challenger's deficient FGs/CPs over time, and that have the right of first refusal.

22. The system of claim 21 further wherein the defender is further validated that:
defender must overlap in time some portion of the challenger;
defender must be queued prior to the challenger;
defender must significantly impact one or more of the challenger's deficient FGs or CPs over the same time interval as the challenger, and
confirmed TSRs (B and C-Defenders) must be “conditional”, with service start time less the current evaluation time must be greater than the unconditional lead time.

23. The system of claim 22 wherein for each of the A, B, and C defender lists are prioritized first by:
duration, from shortest to longest; then
pre-confirmation status, from NO to YES; then
if ignore price is not set, price, from low to high, and then
queue time, from newest to oldest.

24. The system of claim 23 wherein each A defender is excluded if:
TSRs that have any periods of time with a 0 MW capacity will be evaluated with an effective duration equal to the TSR's total duration of service minus the sum of all intervals in time with 0 MW capacity;
any TSR of equal Duration, that is preconfirmed, with a met price condition, and
any TSR of equal Duration that is Preconfirmed or any TSR of equal Duration, not Preconfirmed, with the price condition met.

25. The system of claim 24 wherein each B or C defender is excluded if:
TSRs that have any periods of time with a 0 MW capacity will be evaluated with an effective duration equal to the TSR's total duration of service minus the sum of all intervals in time with 0 MW capacity, and
any TSR of equal Duration, that is preconfirmed, with a met price condition.

26. The system of claim 24 wherein each non-firm B and C evaluation is excluded if:
any TSR of longer duration that have any periods of time with a 0 MW capacity will be evaluated with an effective duration equal to the TSR's total duration of service minus the sum of all intervals in time with 0 MW capacity.

27. The system of claim 24 wherein the computer program of evaluation for preemption and competition is configured to:
determine the best partial service offer available to the challenger;
log the best partial service offer available without preemption and competition;
if any of the A, B, or C-Defender TSRs are identified as being a participant (either defender or challenger) in an active preemption and competition in progress, suspend evaluation for preemption and competition
process and log the identification of the challenging TSR(s) and all of its defenders with those currently being competed;
capture the list of deficient FGs and/or CPs;
for each A-Defender in priority order (lowest to highest), checking that the A-Defender significantly impacts one or more FGs or CPs still deemed to be deficient, and if no deficiency remains for those FGs or CPs significantly impacted by the Defender;
compute and log the best (partial) service offer that may be extended to the challenger resulting from preemption of A-Defenders;
compute the challenger's remaining FG and CP deficiencies over time with all A-Defender and later queued TSR impacts removed;
for each B-Defender in priority order (lowest to highest), for each deficient FG or CP compute the minimum MW capacity that must be recalled from the Defender TSR to meet the deficiency of the challenger over time;
for over all Deficient FGs and CPs, determine the maximum MW capacity over time that must be recalled from the Defender TSR to meet the worst case deficiency of the challenger;
Compute the best (partial) service offer that may be extended to the challenger resulting from preemption of A and B-Defenders, and
check to determine if challenger may be granted in full with preemption of A and B-Defenders.

28. The system of claim 27 wherein if the check is performed and the challenger may not be granted in full with preemption of A and B-Defenders, perform an iterative process of first identifying ALL of the RECALL credits that may be gained by the preemption and competition of the C-Defender and then assessing the feasibility of the C-Defender's right to exercise their ROFR.

29. The system of claim 28 wherein if the defender is of shorter duration than the challenger, compute the required extension to the term of service to match the challenger.

30. The system of claim 29 wherein for each remaining C-Defender in priority order from lowest to highest, determine the feasibility of the MATCHING requirements for competition.

31. The system of claim 30 wherein a final assessment of the challenger is performed by incorporating all SUPERCEDED and RECALL credits gained from preemption and competition but excluding all potential MATCHING impacts from competition.

32. The system of claim 31 further including computing and logging the best partial service offer that may be extended to the challenger resulting from preemption and competition of all qualifying A, B, and C-Defenders.
